(19) United States
(12) Patent Application Publication
(10) Pub. No.: US 2025/0059352 A1
(43) Pub. Date: Feb. 20, 2025

(54) Feeding performance of low-melting Polymer Processing Additive Preblends

(71) Applicant: National Industrialization Company (TASNEE), Riyadh (SA)

(72) Inventors: Jayanta Bera, Al Jubail Industrial City (SA); Mohammed Ali Ghanchi, Al-Jubail Industrial City (SA); Mukesh K. Yadav, Al-Jubail Industrial City (SA)

(21) Appl. No.: 18/906,924

(22) Filed: Oct. 4, 2024

Related U.S. Application Data
(63) Continuation of application No. 18/807,678, filed on Aug. 16, 2024.
(60) Provisional application No. 63/519,933, filed on Aug. 16, 2023.

(51) Int. Cl. C08K 5/526; C08J 3/20; C08K 5/098; C08K 5/103; C08K 5/134; C08K 5/20

(52) U.S. Cl. CPC C08K 5/526; C08J 3/203; C08K 5/098; C08K 5/103; C08K 5/1345; C08K 5/20; C08J 2323/12; C08K 2201/014

(57) ABSTRACT

An additive preblend for production of cap and closure grade polypropylene comprises a mixture of low melting temperature additives and higher melting temperature additives. Inclusion of the higher melting temperature additives eliminates dusting, bridging, and choking issues encountered when adding the lower melting temperature additives separately to a screw feeder for a polypropylene extruder.

### CROSS REFERENCE TO RELATED APPLICATIONS/INCORPORATION BY REFERENCE STATEMENT

This application is a continuation of U.S. Ser. No. 18/807,678, filed Aug. 16, 2024, which claims benefit under 35 USC § 119(e) of U.S. Provisional Patent Application No. 63/519,933, filed Aug. 16, 2023. The entire contents of each of the above-referenced patent application(s) are hereby expressly incorporated by reference.

### BACKGROUND

The following disclosure generally relates to polypropylene manufacture and, more specifically, to low-melting additive preblends for polypropylene cap and closure applications.

A preblend (or no-dust blend) is a homogenous mixture of a number of individual additives which are widely used in industrial polypropylene (PP) and other polymer manufacturing. Additive preblends of erucamide and glycerol monostearate (GMS) are used to produce PP grades for caps & closures applications. Due to the low melting temperature of erucamide and GMS, preblends of erucamide and GMS often have feeding issue in screw feeders of extruders. This is mainly due to poor flow of the preblend caused by early melting of erucamide and GMS. These feeding issues of additive preblends have caused shut down of the extruder in PP plants, and cleaning of feeder screw is required before restarting the production. This causes costly high down times in plant operation.

Additionally, these feeding problems can lead to production of cap and closure grade polypropylene with fluctuations in erucamide and GMS content, and these fluctuations can result in uneven processing of caps in the extrusion compression molding process at caps producers. Due to the criticality of extrusion compression molding of caps and closures, it would be desirable to maintain all additives as per specification and resolve the feeding issue of erucamide and GMS preblends in PP cap & closure grade production without changing the additive specification of this grade.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. In the drawings:

FIG. 1A shows an exemplary erucamide and GMS preblend made using a compaction process.

FIG. 1B shows an exemplary one-pack preblend made using a hot extrusion process.

FIG. 2 is a graph comparing the fines content (≤850 μm) in friability tests of erucamide and GMS preblend and an exemplary one-pack preblend.

### DETAILED DESCRIPTION OF EXEMPLARY EMBODIMENTS

Before explaining at least one embodiment of the present disclosure in detail, it is to be understood that the present disclosure is not limited in its application to the details of construction and the arrangement of the components or steps or methodologies set forth in the following description or illustrated in the drawings. The present disclosure is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the present disclosure shall have the meanings that are commonly understood by those of ordinary skill in the art. Further, unless otherwise required by context, singular terms shall include pluralities and plural terms shall include the singular.

All of the articles and/or methods disclosed herein can be made and executed without undue experimentation in light of the present disclosure. While the articles and methods of the present disclosure have been described in terms of preferred embodiments, it will be apparent to those skilled in the art that variations may be applied to the articles and/or methods and in the steps or in the sequence of steps of the method described herein without departing from the concept, spirit, and scope of the present disclosure. All such similar substitutes and modifications apparent to those skilled in the art are deemed to be within the spirit, scope, and concept of the present disclosure.

As utilized in accordance with the present disclosure, the following terms, unless otherwise indicated, shall be understood to have the following meanings:

The use of the word “a” or “an” when used in conjunction with the term “comprising” in the claims and/or the specification may mean “one”, but it is also consistent with the meaning of “one or more,” “at least one,” and “one or more than one.” The use of the term “or” in the claims is used to mean “and/or” unless explicitly indicated to refer to alternatives only or that the alternatives are mutually exclusive, although the disclosure supports a definition that refers to only alternatives and “and/or.”

Throughout this application, the term “about” is used to indicate that a value includes the inherent variation of error for the device, the method being employed to determine the value, or the variation that exists among the study subjects. For example, but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent. The use of the term “at least one of X, Y, and Z” will be understood to include X alone, Y alone, and Z alone, as well as any combination of X, Y, and Z. The use of ordinal number terminology (i.e., “first,” “second,” “third,” “fourth,” etc.) is solely for the purpose of differentiating between two or more items and is not meant to imply any sequence or order or importance to one item over another or any order of addition, for example.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination unless otherwise apparent from the context.

As used herein, the term “substantially” means that the subsequently described event or circumstance completely occurs or that the subsequently described event or circumstance occurs to a great extent or degree. For example, when associated with a particular event or circumstance, the term “substantially” means that the subsequently described event or circumstance occurs at least 80% of the time, or at least 85% of the time, or at least 90% of the time, or at least 95% of the time. The term “substantially adjacent” may mean that two items are 100% adjacent to one another, or that the two items are within close proximity to one another but not 100% adjacent to one another, or that a portion of one of the two items is not 100% adjacent to the other item but is within close proximity to the other item.

The term “associate” as used herein will be understood to refer to the direct or indirect connection of two or more items.

Preblend (or No-dust blend) is a homogenous mixture of individual additives which are widely used in polypropylene and other polymer manufacturing industries. These preblends are based upon the concept that the lowest melting additive component acts as a binder for the other additives. Erucamide and glycerol monostearate (GMS) are typically added as a preblend to provide slip and antistatic characteristics in polypropylene (PP) grades intended for caps and closures produced by extrusion compression molding. Erucamide and GMS are specifically used in this polypropylene grade to facilitate the extrusion compression molding process and to meet opening torque requirements in screw caps and closures. These additives also act as mold release agents during the extrusion compression molding process for closure production and GMS additionally provides antistatic protection to caps and closures.

Preblends of erucamide and GMS cannot be made by traditional hot extrusion processes, rather compaction processes must be used. However, erucamide/GMS preblends prepared by compaction processes are soft in nature and generate fines in screw feeders which causes choking. Due to the low melting temperature and soft characteristics of erucamide and GMS, preblends made from these two additives can cause feeding issues in extruder screw feeders. Thus, poor flow, high fines generation, and early melting of this kind of preblend causes choking in screw feeders, often requiring shut down and cleaning of the feeder screw prior to restarting production. This can cause significant down time and production loss in polypropylene plants.

As background, U.S. Pat. No. 3,266,924 to Haeske et al. discloses additive mixtures of fine silicious material and fatty acid amide slip agent for polyethylene. U.S. Pat. No. 5,240,642 to Neri et al. discloses granulating powders of organic and inorganic antiacid additives for polymers using heat and pressure. U.S. Pat. No. 6,033,600 to Henkins et al. discloses a stabilizer blend compacted under pressure to form compacted particles such as pellets, exhibiting reduced levels of dust. And U.S. Publication No. 2015/0057398 to Chatterjee and Subrahmanyan describe how high concentrations of low-melting, sticky additives lead to phase separation and extrusion instability, such that pellets cannot be formed from such additive blends by traditional extrusion.

To solve the specific problem of erucamide and glyceryl monostearate (GMS) addition to polypropylene, a novel additive preblend was discovered and produced by hot extrusion. This novel preblend was found to resolve the feeding issue of low melting additives, namely erucamide and glyceryl monostearate (GMS), in extruder manufacturing of polypropylene (PP) caps and closures (C&C) grade. In one embodiment, the novel additive preblend contains more than 70 percent of erucamide and GMS in total, and showed smooth feeding in a PP plant extruder. This novel preblend resolves the feeding issue of erucamide and GMS preblend without changing the additive specification of the PP cap and closure grade. Improved hardness and flowability of the preblend is achieved, thereby substantially reducing down time and reducing or eliminating uniformity issues with PP cap and closure grades due to fluctuation of erucamide and GMS contents.

Nucleating agents are used in the polypropylene grade to provides outstanding balance of high stiffness and improved isotropic dimensional stability in the caps & closure product.

The polypropylene grade under consideration can be produced using two different preblends. One preblend contains two additives, namely erucamide and GMS. Another preblend contains antioxidants, an acid neutralizer, nucleating agents. The present disclosure describes a preblend for improving the feeding of erucamide and GMS in production of polypropylene grade containing erucamide, GMS, antioxidants (Irganox 1010 and Irgafos 168), acid neutralizer (calcium stearate), nucleating agents. This invention resolves the feeding issue of erucamide and GMS preblend without changing the additive specification of the polypropylene grade by improving the hardness and flowability of preblend in line with operation requirement in feeder.

The addition of certain high melting additives in erucamide and GMS increases the resistance to friability of the preblend. These additives are part of additive specification of polypropylene grade and thus have no effects on additive specification of polypropylene grade.

In place of preparing erucamide and GMS preblend by compaction processes, in one embodiment a new preblend was made using antioxidants, acid neutralizer and nucleating agents together with erucamide and GMS by a melt extrusion process as per the specification of the polypropylene grade. The preblend produces was found to be in hard pellets form and having higher resistance to friability compared to erucamide and GMS blend. Significant improvement was verified by friability data of new preblend.

Erucamide and GMS preblends are very soft and sticky in nature. Erucamide and GMS have typical melting temperature of approximately 78° C. and 69° C. respectively. Phenolic antioxidant, phosphite antioxidant, and calcium stearate have higher melting temperature than erucamide and GMS. Incorporation of antioxidants and calcium stearate into a preblend of erucamide and GMS improves hardness of preblend. Typical melting temperature range of phenolic antioxidant, phosphite antioxidant, and calcium stearate are 110-125° C., 182-188° C. and 145-155° C. respectively.

Phenolic antioxidant, phosphite antioxidant, and calcium stearate have higher melting temperature than erucamide and GMS. Thus, incorporation of antioxidants and calcium stearate in erucamide and GMS blend improves the hardness of preblend and subsequently reduces fines. Addition of antioxidants and calcium stearate are envisioned to encapsulate the overall composition of preblend which will subsequently improve hardness and flowability of preblend. Further, necessary improvement in preblend feeding performance can be achieved without changing the composition of preblend for the polypropylene grade.

A different process involving solid state compaction is normally used in the industry for producing additive preblend of erucamide and GMS into flex form with higher fines contents. A typical commercial compacted additive preblend of erucamide and GMS generally contains high fines and fines contents increases during handling and feeding process. In the present disclosure, a novel additive preblend composition developed for a hot extrusion process resolves additive feeding issues for manufacturing of polypropylene grade. Thus, an innovative way for producing a homogeneous mixture of preblended additives comprising about 70% to 80% of erucamide and GMS in total weight percentage of the preblend is disclosed with reduced fines contents and higher harness of preblend.

The present disclosure pertains to producing an additive preblend containing a higher percentage of low melting additives, namely erucamide and GMS, in a pellet form. Due to low melting and sticky nature of additive like erucamide and GMS, traditionally preblends of these additives cannot be processed by traditional melt extrusion process to produce preblend pellets. A different process involving solid state compaction is normally used in the industry for producing additive preblends of erucamide and GMS into flex form with a higher fines contents. The low melting additives typically tends to create sticky melts during melt extrusion processing, such that above a critical concentration of these additives in the preblend, the total blend becomes unextrudable and pellets cannot be produced.

A novel additive preblend composition is processed through hot extrusion process which resolved the previous feeding issue of low melting additives. Additive preblend compositions contain more than 70% of erucamide and GMS in combination. Novel additive preblend shows smooth feeding in extruder during manufacturing of PP grade at PP Plant.

The current invention pertains to compacted additive blends in which high melting additives are used to increase the resistance to friability of the preblend pellets. In addition to this benefit, high melting additives can also minimize melting tendency of low melting erucamide and GMS during feeding process.

The hot extrusion process provides higher homogeneity of additives and hardness in the preblend compared to compaction process. In hot extrusion technology, all the additives are mixed properly in a blender with required percentages. Extruder temperature is kept a little below the softening temperature of lowest melting additive. The additive mixtures are processed through extruder and finally pelletized to get proper pellet form. Addition of high melting antioxidant and calcium stearate additives along with erucamide and GMS facilitate formation of preblend pellets with higher hardness and most of the fines were eliminated.

In one embodiment, a novel additive preblend composition comprises high melting antioxidant and calcium stearate additives along with erucamide and GMS and is made using a hot extrusion process, and resolves the feeding issue of additives for manufacturing of polypropylene grade. The novel additive preblend can easily be fed into an extruder and customer of the polypropylene grade were pleased as feeding of the additive preblend was smooth and no fluctuation observed during feeding of the present preblend.

In one embodiment, additive preblend comprises 45-50% erucamide (Cis-13-Docosenoamide), 25-30% Glyceryl monostearate (Octadecanoic acid, monoester with 1,2,3-propanetriol), 4-6% phenolic antioxidant—Pentaerythritol Tetrakis(3-(3,5-di-tert-butyl-4-hydroxyphenyl) propionate), 10-12% of phosphite antioxidant—Tris(2,4-di-tert-butylphenyl) phosphite, 3-5% of calcium stearate and 1-6% of nucleating agent (combination of 1,2-Cyclohexanedicarboxylic Acid, Calcium Salt and Disodium cis-endo-bicyclo (2.2.1) heptane-2-3-dicarboxylate).

In one embodiment, an additive preblend composition contains more than 70% combined erucamide and GMS and is made using a hot extrusion process. The additive preblend showed smooth feeding during manufacturing of PP grade at the PP Plant.

In one embodiment, the preblend containing erucamide and GMS along with other high melting additives is formulated without changing the additive specification of the target polypropylene grade and is made with a hot extrusion process.

In one embodiment, a mixture of seven different additives is used which is a unique preblend type in industry. Higher numbers of additives in preblends are considered difficult because of the difficulty in maintaining uniformity in the preblend. However, the presently disclosed preblend is uniform in nature, stable in physical form, and free of fines.

Because the presently disclosed preblend incorporates all or most of the additives, it is sometimes referred to hereinafter as a one-pack preblend. The one-pack preblend replaces a two preblend system in which one preblend was made up of erucamide and GMS and another preblend contained phenolic antioxidant, phosphite antioxidant, calcium stearate, and nucleating agents. The one-pack preblend is easy handled and resolves the feeding issue in the extruder.

In one embodiment, the surface area of erucamide and GMS was reduced from 100% in erucamide/GMS preblend to 65% in the one-pack preblend as others additives become part of the one-pack preblend. Due to a lower percentage of erucamide and GMS in the one-pack preblend, the surface contact area of low melting additives in the one-pack preblend is reduced from 100% in erucamide/GMS preblend to 65% in one-pack preblend. Lower surface contact area of low melting additive in preblend is believed to cause less melting of preblend during the feeding process as well as fines generation, thereby resolving the feeding issue at plant level. Testing showed that fines generation is much higher in erucamide and GMS preblend compared to the one-pack preblend. Sieve retention and friability tests were conducted to evaluate the stability of forms of preblend during abrasion. This test helps to determine the fines generation and hardness of the preblends, which is an indicator of performance of the preblend in a screw feeder.

In summary, one-pack preblend for PP caps and closures grade resolved production issues at the screw feeder in the PP plant. Further, the one-pack preblend in homo-PP improves the grade characteristics suitable for cap and closures processing in extrusion compression molding processes. And the one-pack preblend for PP caps and closures grade was made without changing the additive specification of the PP grade.

### Examples

Preblends containing higher percentages of erucamide and GMS were prepared. In one test, a powder blend having components identified in Table 2 was prepared.

TABLE 2

| | | Manu- | Amount |
|---|---|---|---|
| Additive Name | Chemical Name | facturer | (wt %) |
| Crodamide ER | Cis-13-Docesenomide | Croda | 44.6-48.6 |
| Atmer 129V | Octadecanoic acid, | Croda | 25.6-27.6 |
| | monoester with | | |
| | 1,2,3-propanetriol | | |
| Anox 20 | Pentaerythritol | GSI | 4.8-5.8 |
| | Tetrakis(3-(3,5-di- | | |
| | tert-butyl-4-hydroxyphenyl) | | |
| | propionate) | | |
| Alkanox 240 | Tris(2,4-di-tert-butylphenyl) | GSI | 10.2-11.2 |
| | phosphite | | |
| Calcium | Calcium stearate | Faci | 3.5-4.5 |
| stearate | | | |
| HPN 20E | 1,2-Cyclohexanedicarboxylic | Milliken | 4.5-5.5 |
| | Acid, Calcium Salt | | |
| HPN 68L | Disodium cis-endo-bicyclo | Milliken | 1.5-1.7 |
| | (2.2.1) heptane-2-3- | | |
| | dicarboxylate) | | |

Additives were weighed and charged into a ribbon blender for homogenous mixing. Homogeneously mixed additives were fed into an extruder through a K-tron feeder. The homogeneously mixed additives were introduced into a Coperion twin screw extruder. The powder blend was processed through the screw extruder with suitable screw speed and temperature conditions as shown in Table 3 below.

TABLE 3

| Extruder Zone | Temperature (° C.) |
|---|---|
| Zone 1 | 50 |
| Zone 2 | 50 |
| Zone 3 | 55 |
| Zone 4 | 55 |
| Zone 5 | 55 |
| Die | 55 |

The extrudate was passed through a die with a single row of 2.5 mm diameter holes. The extruded strands were cooled on stainless steel, and cooled strands fragmented via a pneumatic conveyance. The resultant material was passed through a sieve tower and the pellets falling between 2 mm and 6 mm constituted the preblend granules.

Two commercial batches of PP caps grade were produced in a commercial PP plant with one-pack preblend. The additive content in the PP commercial batches were analyzed and were found to be within the specification range. During operation, one-pack preblend ran smoothly without any feeding issues in the PP plant extruder.

Physical, mechanical, and thermal properties of commercial batches produced with one-pack preblend were analyzed and found well within target specification range. Commercial batches of PP grade were analyzed for processability at a high speed extrusion compression molding line. Processability of the PP batches was found to be very good and well accepted by caps and closures customers. Improvement in feeding performance of the preblend led to a reduction in down time of polypropylene plant and resolved customer complaints on polypropylene grade used for extrusion compression molding process for caps & closures applications.

The preblends were tested for Sieve retention and friability to evaluate stability of forms of preblend. This test helps to determine the fines generation and hardness of the preblends which indicates performance of preblend in a screw feeder.

The test was performed by first weighing 100 grams of the preblend samples. The samples were then placed on the top of a stack of sieves in sieve shaker with 4.45 mm, 3.34 mm, 2.36 mm, 1.70 mm, 850 μm, 600 μm, 425 μm, 106 μm screens sizes with a solid pan at the bottom of the stack. Sieve shaker by setting the vibration time of 5 minutes were started and after the sieves were taken out from the shaker and weigh the individual sieves separately to find out the percentage retention with respect to the total sample taken.

In friability test, glass balls of 15 mm diameter were added to each sieve for which testing was done keeping 4 balls in 106 μm, 5 balls in 425 μm sieve, 6 balls in 600 μm sieve, 7 balls in 850 μm sieve, 8 balls in 1.7 mm sieve, 9 balls in 2.36 mm sieve, and 9 balls in 3.35 mm. Sieve shaker was started after setting the vibration time to 5 minutes. The sieves were then taken out from the shaker and weighed individually to find the percentage retention. The samples were then returned, the time was set to 10 minutes, and the shaker was started. Again, the individual sieves were weighed separately to find out the percentage retention with respect to the total sample taken after 10 minutes, and then after 15 minutes and 20 minutes. Sieve retention and friability test were conducted for preblend of erucamide, GMS and one-pack preblend to comparatively evaluate the fines contents and hardness of these preblends.

Sieve and friability test results of preblend of erucamide and GMS are shown in Table 4 below.

TABLE 4
Sieve and Friability test results
of Preblend of Euracamide and GMS

| | | Sieve | Friability Results (%) | | |
|---|---|---|---|---|---|
| Sieve Size | | retention % | After 5 min | After 10 min | After 20 min |
| 3.35 | mm | 13.4 | 1.1 | 0.4 | 0.2 |
| 2.36 | mm | 47.9 | 42.9 | 34.7 | 7.8 |
| 1.70 | mm | 26.1 | 19.4 | 13 | 3.0 |
| 850 | μm | 8.8 | 11.1 | 11.8 | 12.9 |
| 600 | μm | 1.5 | 2.8 | 3.5 | 7.5 |
| 425 | μm | 1 | 7.9 | 12.7 | 26.2 |
| 106 | μm | 1.1 | 13 | 20.3 | 37.2 |

| | | | | |
|---|---|---|---|---|
| Pan | 0.2 | 1.8 | 3.6 | 5.2 |

The sieve and friability test results of One-pack are given in Table 5 below.

TABLE 5
Sieve and Friability test results of One-pack Preblend

| | | Sieve | Friability Results (%) | | |
|---|---|---|---|---|---|
| Sieve Size | | retention % | After 5 min | After 10 min | After 20 min |
| 4.45 | mm | 4.0 | 1.1 | 0 | 0 |
| 3.35 | mm | 17.4 | 11.6 | 8.3 | 0.9 |
| 2.36 | mm | 78.6 | 87.1 | 91.6 | 98.7 |
| 1.70 | mm | 0 | 0.07 | 0 | 0 |
| 850 | μm | 0 | 0.07 | 0.03 | 0 |
| 600 | μm | 0 | 0.01 | 0 | 0.01 |
| 425 | μm | 0 | 0 | 0 | 0 |
| 106 | μm | 0.03 | 0.04 | 0 | 0.17 |

| | | | | |
|---|---|---|---|---|
| Pan | 0 | 0.07 | 0.13 | 0.21 |

The fines content (≤850 μm) in friability tests of erucamide and GMS preblend and One-pack preblend are shown in FIG. 2. The fines contents of erucamide and GMS Blend and One-pack blend were compared before and after friability test and results are shown in Table 6.

TABLE 6
Comparative data of fines content and friability test for preblends

| | Erucamide/ | One-pack |
|---|---|---|
| Tests | GMS Preblen | Preblend |
| Fines ≤850 μm; % | 12.6 | 0.03 |
| Friability test; Fines ≤850 | 89 | 0.39 |
| μm (after 20 mins); % | | |
| % Difference (Δ fines) | 76.4 | 0.36 |

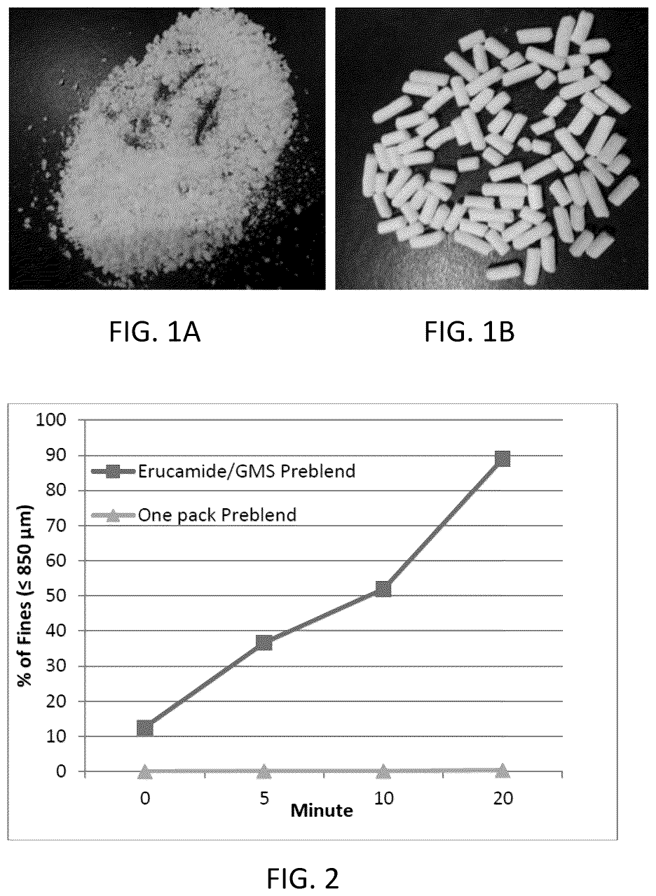

Friability test data indicates that one-pack preblend is a much more stable and harder blend compared to erucamide and GMS preblend. As shown in FIG. 1A and FIG. 1B, one-pack preblend produced by hot extrusion process is in pellet form while Erucamide and GMS preblend is in flex form with very high fines. Improvement in form retention was clear in testing.

One-pack preblend for PP caps & closures grade resolved the issues in screw feeding. One-pack preblend in homo-PP improves the grade characteristics suitable for cap & closures processing in extrusion compression molding process. Further, the one-pack preblend for PP caps & closures grade was made without changing additive specification of the PP grade.

Thus, in accordance with the presently disclosure, there has been provided a method for manufacturing polypropylene for caps and closures using a one-pack preblend as described above. Although the presently disclosure has been described in conjunction with the specific language set forth herein above, it is evident that many alternatives, modifications, and variations will be apparent to those skilled in the art. Accordingly, it is intended to embrace all such alternatives, modifications, and variations that fall within the spirit and broad scope of the present disclosure. Changes may be made in the construction of the various components, elements, and assemblies described herein, without departing from the spirit and scope of the present disclosure.

What is claimed is:

1. An additive preblend for production of thermoplastics, the additive preblend comprising a mixture of a lower melting temperature additive and a higher melting temperature additive.

2. The additive preblend of claim 1, wherein the lower melting temperature additive comprises erucamide and glyceryl monostearate.

3. The additive preblend of claim 2, wherein the preblend contains at least 70% lower melting temperature additive.

4. The additive preblend of claim 3, wherein the higher melting temperature additive comprises an antioxidant, an acid neutralizer, and a nucleating agent.

5. The additive preblend of claim 3 wherein the higher melting temperature additive comprises phenolic antioxidant and phosphite antioxidant and calcium stearate.

6. The additive preblend of claim 2, wherein the additive preblend is produced through a hot extrusion process.

7. The additive preblend of claim 6, wherein the additive preblend is formulated without changing the additive specification of the target polypropylene grade.

8. The additive preblend of claim 6, wherein the additive preblend is in a pellet form.

9. The additive preblend of claim 8, wherein the additive preblend comprises 45-50% erucamide, 25-30% glyceryl monostearate, 4-6% phenolic antioxidant, 10-12% phosphite antioxidant, 3-5% calcium stearate, and 1-6% of nucleating agent.

10. The additive preblend of claim 9, wherein the nucleating agent comprises a combination of 1,2-cyclohexanedicarboxylic acid, calcium salt, and disodium cis-endo-bicyclo (2.2.1) heptane-2-3 dicarboxylate.

11. The additive preblend of claim 1, wherein the additive preblend comprises seven different additives.

12. An additive preblend for production of cap and closure grade polypropylene, wherein the additive preblend contains seven different additives.

13. The additive preblend of claim 12, wherein the different additives are incorporated into a one-pack preblend.

14. The additive preblend of claim 13, wherein the one-pack preblend is in a pellet form made by hot extrusion.

15. The additive preblend of claim 13, wherein the one-pack preblend comprises 45-50% erucamide, 25-30% glyceryl monostearate, 4-6% phenolic antioxidant, 10-12% phosphite antioxidant, 3-5% calcium stearate, and 1-6% of nucleating agent comprising a combination of 1,2-cyclohexanedicarboxylic acid, calcium salt, and disodium cis-endo-bicyclo (2.2.1) heptane-2-3 dicarboxylate.

16. A method for manufacturing polypropylene for production of cap and closures using a one-pack preblend, the method comprising the following steps:
mixing a lower temperature melting additive comprising erucamide and glyceryl monostearate with at least one higher melting temperature additive required for a specified cap and closure grade polypropylene to form a preblend mixture;
feeding the preblend mixture of erucamide, glyceryl monostearate, and the at least one higher melting temperature additive through a hot extruder to form pellets; and
feeding the pellets, polypropylene, and any additional additives through a screw feeder to an extruder to make the specified cap and closure grade polypropylene.

17. The method of claim 16, wherein the higher melting temperature additive comprises an antioxidant, an acid neutralizer, and a nucleating agent.

18. The method of claim 16, wherein the preblend mixture comprises at least 70% lower temperature melting additive.

19. The method of claim 16, wherein the preblend mixture comprises 45-50% erucamide, 25-30% glyceryl monostearate, 4-6% phenolic antioxidant, 10-12% phosphite antioxidant, 3-5% calcium stearate, and 1-6% of nucleating agent.

20. The method of claim 19, wherein the nucleating agent comprises a combination of 1,2-cyclohexanedicarboxylic acid, calcium salt, and disodium cis-endo-bicyclo (2.2.1) heptane-2-3 dicarboxylate.
